(19) United States
(12) Patent Application Publication
(10) Pub. No.: US 2014/0320602 A1
(43) Pub. Date: Oct. 30, 2014

(54) Method, Apparatus and Computer Program Product for Capturing Images

(71) Applicant: Nokia Corporation, Espoo (FI)

(72) Inventors: Krishna Annasagar Govindarao, Bangalore (IN); Juha Heikki Alakarhu, Helsinki (FI)

(21) Appl. No.: 14/357,622

(22) PCT Filed: Nov. 19, 2012
(86) PCT No.: PCT/FI2012/051135

§ 371 Date: May 13, 2014

(30) Foreign Application Priority Data
Dec. 2, 2011 (IN) 4189/CHE/2011

(51) Int. Cl. H04N 13/00; H04N 13/02

(52) U.S. Cl. CPC H04N 13/0037; H04N 13/0257; H04N 13/0022; H04N 2013/0077; H04N 2013/0081
USPC 348/46

(57) ABSTRACT

In accordance with various example embodiments, methods, apparatuses, and computer program products are provided. A method comprises receiving a panchromatic image of a scene captured from a panchromatic image sensor, receiving a colour image of the scene captured from a colour image sensor, and generating a modified image of the scene based at least in part on processing the panchromatic image and the colour image. The apparatus comprises at least one processor and at least one memory, configured to, cause the apparatus to perform receiving a panchromatic image of a scene captured from a panchromatic image sensor, receiving a colour image of the scene captured from a colour image sensor, and generating a modified image of the scene based at least in part on processing the panchromatic image and the colour image.

### TECHNICAL FIELD

Various implementations relate generally to method, apparatus, and computer program product for image capturing applications.

### BACKGROUND

Various electronic devices such as cameras, mobile phones, and other devices are integrated with capabilities of capturing two-dimensional (2-D) and three-dimensional (3-D) images, videos, animations. These devices often use stereo camera pair having color image sensors, that enables a multi-view capture of a scene which can be used to construct a 3-D view of the scene. By using two cameras, there are no other benefits apart from capturing 3-D images of the scene in such devices.

### SUMMARY OF SOME EMBODIMENTS

Various aspects of examples embodiments are set out in the claims.

In a first aspect, there is provided a method comprising: receiving a panchromatic image of a scene captured from a panchromatic image sensor; receiving a colour image of the scene captured from a colour image sensor; and generating a modified image of the scene based at least in part on processing the panchromatic image and the colour image.

In a second aspect, there is provided an apparatus comprising: at least one processor and at least one memory, configured to, cause the apparatus to perform receiving a panchromatic image of a scene captured from a panchromatic image sensor; receiving a colour image of the scene captured from a colour image sensor; and generating a modified image of the scene based at least in part on processing the panchromatic image and the colour image.

In a third aspect, there is provided a computer program product comprising at least one computer-readable storage medium, the computer-readable storage medium comprising a set of instructions, which, when executed by one or more processors, cause an apparatus to at least perform: receiving a panchromatic image of a scene captured from a panchromatic image sensor; receiving a colour image of the scene captured from a colour image sensor; and generating a modified image of the scene based at least in part on processing the panchromatic image and the colour image.

In a fourth aspect, there is provided an apparatus comprising: means for receiving a panchromatic image of a scene captured from a panchromatic image sensor; means for receiving a colour image of the scene captured from a colour image sensor; and means for generating a modified image of the scene based at least in part on processing the panchromatic image and the colour image.

In a fifth aspect, there is provided a computer program comprising program instructions which when executed by an apparatus, cause the apparatus to: receive a panchromatic image of a scene captured from a panchromatic image sensor; receive a colour image of the scene captured from a colour image sensor; and generate a modified image of the scene based at least in part on processing the panchromatic image and the colour image.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for capturing images in accordance with an example embodiment;

FIG. 3 is a flowchart depicting an example method for capturing images in accordance with another example embodiment;

FIG. 4 is a flow diagram representing an example of capturing images in accordance with an example embodiment;

FIG. 5 is a flow diagram representing an example of capturing images in accordance with another example embodiment;

FIG. 6 is a flow diagram representing an example of capturing 3-D images in accordance with an example embodiment; and

FIG. 7 is a flow diagram representing an example of capturing 3-D images in accordance with another example embodiment.

### DETAILED DESCRIPTION

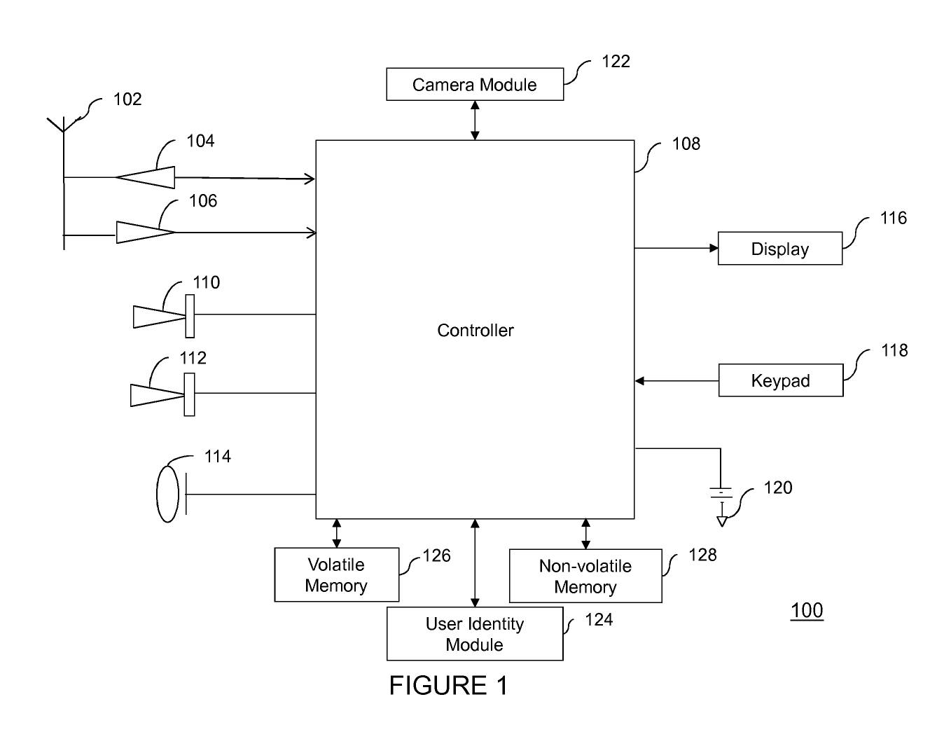

Example embodiments and their potential effects are understood by referring to FIGS. 1 through 7 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

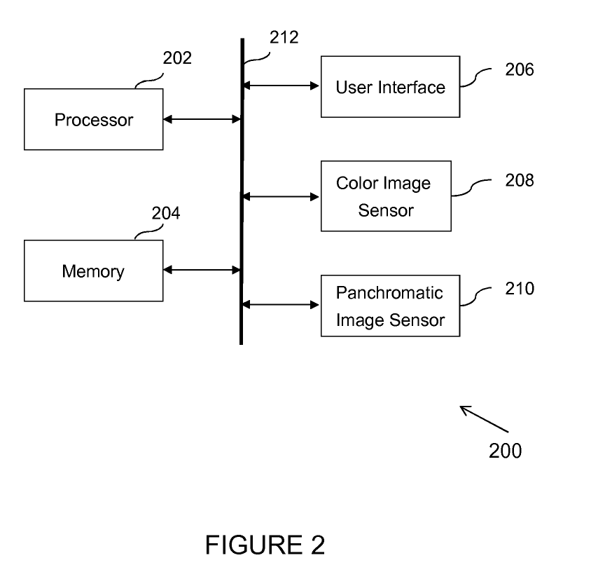

FIG. 2 illustrates an apparatus 200 for capturing images in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), a graphic processing unit (GPU), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the electronic device may be a camera. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device and/or the media capturing device may be embodied as to include color image sensors, such as a color image sensor 208. The color image sensor 208 may be in communication with the processor 202 and/or other components of the apparatus 200. The color image sensor 208 may be in communication with other imaging circuitries and/or software, and is configured to capture digital images or to make a video or other graphic media files. The color image sensor 208 and other circuitries, in combination, may be an example of the camera module 122 of the device 100. In an example embodiment, color image sensor 208 may be an image sensor on which a color filter array (CFA) is disposed. Image sensors constructed using semiconductor materials such as CMOS based sensors, or charged coupled devices (CCD) sensors are not color or wavelength sensitive, and therefore in color image sensors such as the color image sensor 208, the CFA is disposed over the image sensors. In an example embodiment, the CFA may be a mosaic of color filters disposed on the image sensor for sampling primary colors. Examples of the primary colors may non-exhaustively include red, green and blue (RGB), and cyan, magenta, and yellow (CMY).

In an example embodiment, the communication device may be embodied as to include a panchromatic image sensor, such as a panchromatic image sensor 210. The panchromatic image sensor 210 may be in communication with the processor 202 and/or other components of the apparatus 200. The panchromatic image sensor 210 may be in communication with other imaging circuitries and/or software, and is configured to capture digital images or to make a video or other graphic media files. The panchromatic image sensor 208 and other circuitries, in combination, may be an example of the camera module 122 of the device 100. In an example embodiment, the panchromatic image sensors may be an image sensor comprising panchromatic pixels. In an example embodiment, color filter array pattern may be modified to contain a ‘P’ pixel (panchromatic pixel) in addition to the three color primaries (RGB). The advantage is that the P pixel is several times more sensitive to light than pixels with a RGB color filter. As a result, in low light, the image quality captured from the panchromatic image sensor 210 is significantly better than that of the color image sensor 208 having CFA.

These components (202-210) may communicate to each other via a centralized circuit system 212 for capturing of 2-D and 3-D images. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 212 may also, or alternatively, include other printed circuit assemblies (PCAs) or communication channel media.

In an example embodiment, the processor 202 is configured to, with the content of the memory 204, and optionally with other components described herein, to cause the apparatus 200 to capture images. In an example embodiment, the apparatus 200 is caused to receive a panchromatic image of a scene captured from a panchromatic image sensor. In an example embodiment, the panchromatic image sensor may be an example of the panchromatic image sensor 210 that is a part of the apparatus 200. In some example embodiment, the panchromatic image sensor 210 may be external, but accessible and/or controlled by the apparatus 200. In an example embodiment, the panchromatic image captured by the panchromatic image sensor is a luminance or a gray scale image. In an example embodiment, pixels corresponding to the panchromatic image sensor 210 are more sensitive to light than pixels corresponding to the color image sensor 208 (having CFA overlaid on a semiconductor based image censor). In this description, the panchromatic image is also referred to as ‘luminance image’. The scene may include at least one object unfolding in surrounding area of the panchromatic image sensor 202 than can be captured by the image sensors, for example, a person or a gathering, birds, books, a playground, natural scenes such as a mountain, and the like present in front of the panchromatic image sensor 202.

In an example embodiment, the processor 202 is configured to, with the content of the memory 204, and optionally with other components described herein, to cause the apparatus 200 to receive a color image of the scene. In an example embodiment, the color image is captured by the color image sensor such as the color image sensor 208 of the apparatus 200. In certain example embodiments, the color image sensor 210 may be external, but accessible and/or controlled by the apparatus 200. In an example embodiment, the apparatus 200 is caused to receive image samples from the color image sensor 208, and perform demosaicing of the image samples to generate the color image. In certain example embodiment, other techniques may also be utilized to generate color image from incomplete image samples received from the color image sensors 208. In an example embodiment, the color image may be in a primary color format such as an RGB image, and the like.

In an example embodiment, the processor 202 is configured to, with the content of the memory 204, and optionally with other components described herein, to cause the apparatus 200 to generate a modified image of the scene based at least in part on processing the panchromatic image and the colour image. In an example embodiment, the modified image may be an improved 2-D image than the colour image in terms of quality in cases where the scene is captured in a low light condition. Panchromatic pixels corresponding to the panchromatic image sensor 210 is significantly more sensitive to light compared to colour filtered pixels corresponding to the colour image sensors having CFA, such as the colour image sensor 208. For instance, in low light scenes where exposure time cannot be increased beyond a limit (as motion blur may affect the captured image), the signal to noise ratio (SNR) for the images captured by the panchromatic sensor 210 is higher than that of the images captured by the colour image sensor 208. As, the panchromatic pixels are more sensitive to light than the colour filtered pixels, more dynamic range of the images can be captured from the panchromatic pixels. In various example embodiments, the apparatus 200 is caused to utilize a luminance image from the panchromatic pixel and a chrominance component from a colour image to generate a modified image (2-D image) that is superior in quality than the colour image received from the colour image sensor 208. For a scene, in normal lighting condition, as the panchromatic image sensor 210 is more sensitive than a conventional camera, the scene can be captured with an exposure time lower than the conventional camera for comparable image quality. As exposure or shutter time reduces that leads to reduction or elimination of motion blur (camera motion or subject motion in the scene). If lower exposure time can be used, that the digital gain or ISO can be low and this leads to reduced noise or grains in the captured image.

In an example embodiment, the apparatus 200 is caused to generate the modified image by determining a warp matrix based on feature points associated with panchromatic image and feature points associated with the colour image. Examples of the feature points may include, but are not limited to, corners, edges of an image, or other region of interest such as background of the scene. In an example embodiment, the apparatus 200 is caused to determine a chrominance component associated with the colour image, and warping the chrominance component of the colour image corresponding to the panchromatic image using the warp matrix. In an example embodiment, the apparatus 200 is caused to generate the modified image based on processing the panchromatic image and the warped chrominance component. In an example embodiment, the apparatus 200 is caused to combine the panchromatic image and the warped chrominance component to generate the modified image.

In an example embodiment, the apparatus 200 is caused to determine the warp matrix by determining feature points associated with the panchromatic image and the color image. In an example embodiment, the apparatus 200 is caused to determine the feature points associated with the color image by determining feature points associated with a grey scale image of the color image. In an example embodiment, the apparatus 200 is caused to perform a grey scale conversion of the colour image to generate the grey scale image, and to determine the feature points associated with the grey scale image. In an example embodiment, the apparatus 200 may be caused to use algorithms such as scale-invariant feature transform (SIFT), Harris corner detector, smallest univalue segment assimilating nucleus (SUSAN) corner detector, features from accelerated segment test (FAST) for determining feature points associated with the gray scale image and the panchromatic image (for example, the luminance image). In an example embodiment, the apparatus 200 is caused to determine correspondence information between the feature points associated with the grey scale image and the feature points associated with the panchromatic image. In an example embodiment, the apparatus 200 is caused to determine the correspondence information using algorithms such as random sample consensus (RANSAC). In an example embodiment, the apparatus 200 is caused to compute the warp matrix based on the correspondence information.

In an example embodiment, the apparatus 200 is caused to determine the chrominance component of the color image by decomposing the color image into a luminance-chrominance format. In an example embodiment, the color image is a color image in primary color format such as an RGB image. In an example embodiment, the apparatus 200 is caused to perform a demosaicing of the image samples received from colour image sensor 208 to generate the colour image, wherein the colour image is in a primary colour format such as RGB or CMY. In an example embodiment, the chrominance component of the color image (for example the RGB image) may be denoised to generate smooth chrominance component. In various examples, chrominance component of a color image varies smoothly as compared to luminance component of the color image. Such property of the chrominance component is utilized by some example embodiments in denoising the chrominance component without much perceivable loss in sharpness of the color image.

In an example embodiment, the apparatus 200 is caused to warp the chrominance component of the colour image corresponding to the panchromatic image using the warp matrix. In an example embodiment, the apparatus 200 may be caused to warp the denoised chrominance component corresponding to the panchromatic image using the warp matrix.

In an example embodiment, the apparatus 200 is caused to generate the modified image from a view of the panchromatic image sensor 210 based on the panchromatic image and the warped chrominance component. In an example embodiment, the modified image may be generated by combining the luminance image (for example, the panchromatic image) and the warped chrominance component. In an example embodiment, the modified image is a modified color image of the color image in one of the primary color formats such as in the RGB format. In an example embodiment, the modified image is an improved image in terms of quality from images individually received from the panchromatic image sensor 210 and the color image sensor 208. For instance, the modified image is a color image generated from processing the luminance image of the panchromatic image sensor 210 and the warped chrominance component (that is in view of the an image captured from the panchromatic image sensor 210), which in turn, provides the modified image with a higher SNR than the color image (RGB) received from the color image sensor 208. In an example embodiment, the modified image may have a better quality than the image otherwise captured by the panchromatic image sensor 210 and the color image sensor 208, as it is generated based on the luminance of the panchromatic image (which is more sensitive to light) and color component (for example, the chrominance component) of the color image.

In another example embodiment, the modified image can also be generated from a view of the color image sensor 208 by processing the chrominance component (of the color image) and the warped panchromatic image corresponding to the view of the color image sensor 208. For instance, in this example embodiment, the apparatus 200 is caused to warp the panchromatic image corresponding to the chrominance component (of the colour image) using the warp matrix. In an example embodiment, the apparatus 200 may be caused to warp the panchromatic image corresponding to the denoised chrominance component using the warp matrix. In an example embodiment, the apparatus 200 is caused to generate the modified image based on the warped panchromatic image and the chrominance component. In an example embodiment, the modified image is a modified color image of the color image in one of the primary color formats such as in the RGB format. In an example embodiment, the modified image is an improved image in terms of quality from images individually received from color image sensor 208 and the panchromatic image sensor 210.

In an example embodiment, the apparatus 200 is caused to generate a depth map based on the feature points associated with the panchromatic image and the feature points associated with the gray scale image of the color image. In an example embodiment, the apparatus 200 may be caused to use the correspondence information between the feature points associated with the panchromatic image and the feature points associated with the gray scale image. In various example embodiments, the apparatus 200 is caused to generate a 3-D image based on processing the modified image from the view of the panchromatic image sensor and the modified image from the view of the colour image sensor using the depth map. As the 3-D image is generated from both the color images with luminance of the panchromatic image, the 3-D image is generated of high SNR (because of panchromatic image being used). In another example embodiment, the apparatus 200 is caused to generate a 3-D image of the scene based on processing the color image (received from the color image sensor 208) and the modified image (generated from combining the luminance image from the panchromatic image sensor 210 and the warped chrominance component) using the depth map.

The 3-D image obtained from various example embodiments are superior in quality as compared to a 3-D image generated from a stereo pair of color image sensors (each having CFA disposed over an image sensor). For instance, in various example embodiments, the apparatus 200 is caused to generate the 3-D image by processing one luminance image (the panchromatic image) and one RGB image (the color image). In various example embodiments, the apparatus 200 is caused to determine the depth map using the luminance or gray scale images from both the sensors (the sensors 208 and 210), and the apparatus 200 is further caused to generate the 3-D image by obtaining a color image corresponding to the panchromatic image sensor from the color image of the color image sensor 208 using the warp matrix. In various example embodiments, the 3-D image is generated by utilizing the luminance image (captured by the sensor 210) having higher sensitivity in low light conditions, and the color image of the color image sensor 208, and accordingly, the 3-D image generated by various example embodiments offer a superior quality as compared to a 3-D image generated from a stereo pair of color image sensors. In various example embodiments, the 3-D image may be generated from a first color image (generated from combining warped and denoised chrominance component and panchromatic image) and from a second color image (received from combining warped panchromatic image and the denoised chrominance component).

In an example embodiment, the pixels count of the sensors such as the color image sensor 208 and the panchromatic image sensor 210 may be different. For instance, the panchromatic image sensor 210 may have a pixel count of 8 megapixels and the color image sensor 208 may have a pixel count of 2 megapixels. As various example embodiments utilize only the chrominance component of the color image received from the color image sensor 208, the pixel count of the color image sensor 208 may be less than the pixel count of the panchromatic image sensor 210. As the signal to noise ratio (SNR) for the images captured by the color image sensor 208 is lower than the images captured by the panchromatic image sensor 210, and this can be mitigated by reducing the pixel count (for example, increasing the pixel area for a pixel) of the color image sensor 208. As the pixel area of the color image sensor 208 increases, the SNR for the images captured by the color image sensor 208 also increase. In such example embodiments, the apparatus 200 is caused to upsample the chrominance component of the color image with respect to the pixel count of the panchromatic image before warping the chrominance component of the color image corresponding to the panchromatic image using the warp matrix. In an example embodiment, the chrominance component may be upsampled by a ratio of the pixel count of the panchromatic image sensor 210 and the pixel count of the color image sensor 208 (for example, by 4). As the chrominance image is a low pass signal, upsampling the chrominance image does not introduce artifacts or have an adverse effect on the sharpness of the chrominance image.

In various example embodiments, an apparatus such as the apparatus 200 may comprise various components such as means for receiving a panchromatic image of a scene captured from a panchromatic image sensor, means for receiving a colour image of the scene captured from a colour image sensor, and means for generating a modified image of the scene based at least in part on processing the panchromatic image and the colour image. Such components may be configured by utilizing alone or combination of hardware, firmware and software components. Examples of such means may include, but are not limited to, the processor 202 along with memory 204, the UI 206, the colour image sensor 208 and the panchromatic image sensor 210.

In an example embodiment, the means for generating the modified image comprises means for determining a warp matrix based on feature points associated with panchromatic image and feature points associated with the colour image, means for determining a chrominance component associated with the colour image, means for warping the chrominance component of the colour image corresponding to the panchromatic image using the warp matrix, and means for generating the modified image based on processing the panchromatic image and the warped chrominance component. In an example embodiment, the apparatus also includes means for warping the panchromatic component to correspond to the view of the colour image and means for generating the modified image based on processing the denoised chrominance component and the warped panchromatic image. In an example embodiment, the means for receiving the colour image comprises means for performing a demosaicing of image samples received from the colour image sensor to generate the colour image, wherein the colour image is in a primary colour format. Examples of such means may non-exhaustively include the processor 202 along with the memory 204, the UI 206, the colour image sensor 208 and the panchromatic image sensor 210.

In an example embodiment, means for generating the warp matrix comprises means for performing a grey scale conversion of the colour image to generate a grey scale image of the colour image, means for determining the feature points associated with the colour image by determining feature points associated with the grey scale image, and means for determining the feature points associated with the panchromatic image, means for determining correspondence information between the feature points associated with the grey scale image and the feature points associated with the panchromatic image, and means for computing the warp matrix based on the correspondence information. In an example embodiment, means for generating the chrominance component comprises means for performing a demosacing of image samples received from the colour image sensor to generate the colour image, and means for performing decomposition of the colour image to determine a luminance component and the chrominance component. In an example embodiment, the means for warping comprises means for denoising the chrominance component and means for warping the denoised chrominance component corresponding to the panchromatic image using the warp matrix. The panchromatic image can also be warped corresponding to the view of the colour image sensor 208. Examples of such means may non-exhaustively include the processor 202 along with the memory 204, the UI 206, the colour image sensor 208 and the panchromatic image sensor 210.

In an example embodiment, the apparatus further comprises means for determining a depth map based on the feature points associated with the panchromatic image and the feature points associated with the colour image, and means for generating a three-dimensional image of the scene based on processing and the colour image and the modified image using the depth map. In this example embodiment, the apparatus further comprises means for upsampling the chrominance component of the colour image prior to warping the chrominance component, wherein a pixel count of the colour image sensor is less than a pixel count of the panchromatic image sensor. Examples of such means may non-exhaustively include the processor 202 along with the memory 204, the UI 206, the colour image sensor 208 and the panchromatic image sensor 210.

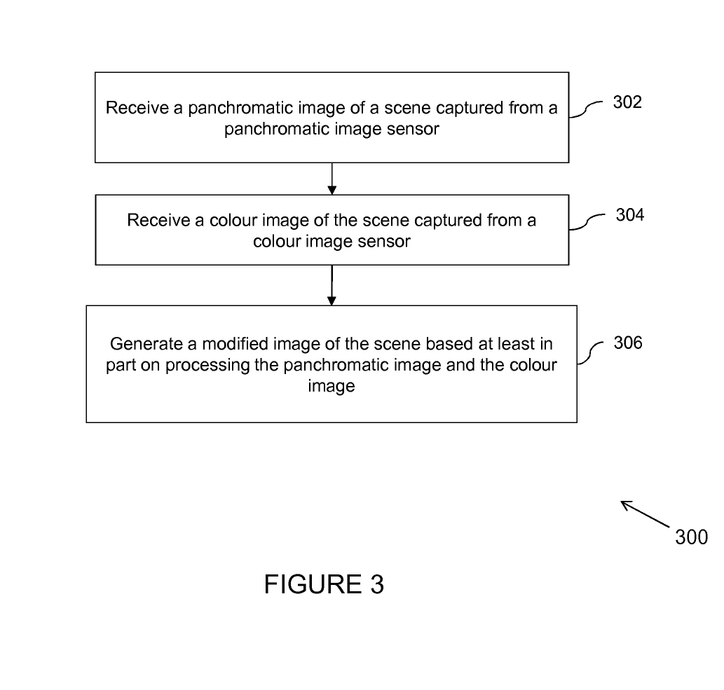

FIG. 3 is a flowchart depicting an example method 300 in accordance with an example embodiment. The method 300 depicted in flow chart may be executed by, for example, the apparatus 200. It may be understood that for describing the method 300, references herein may be made to FIGS. 1 and 2.

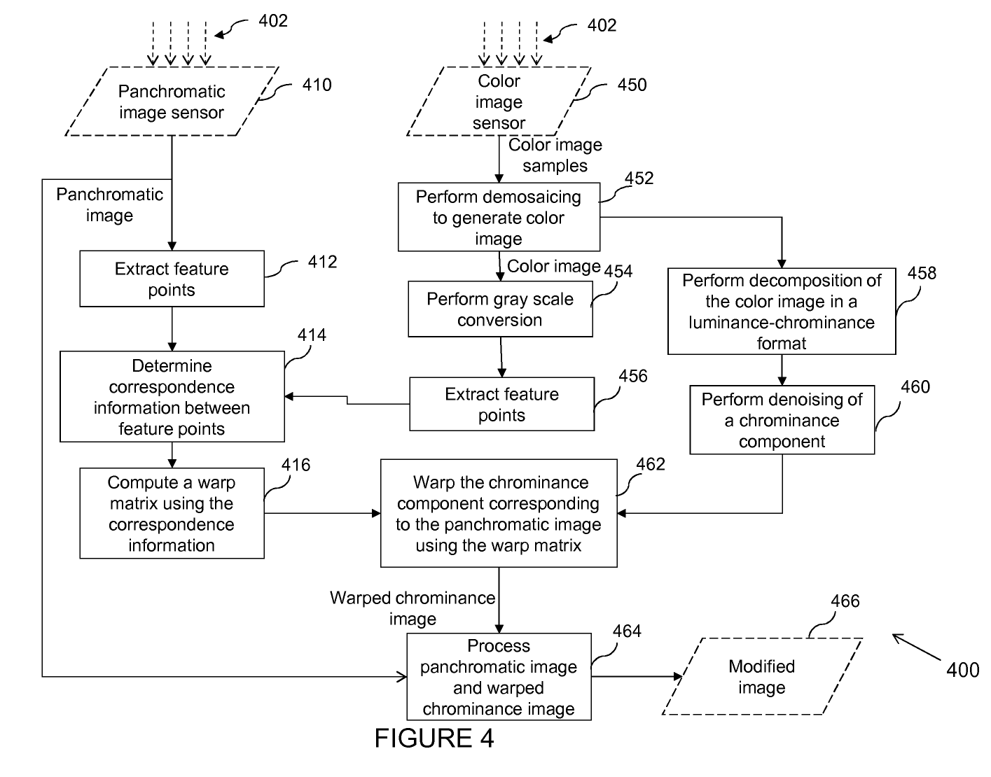

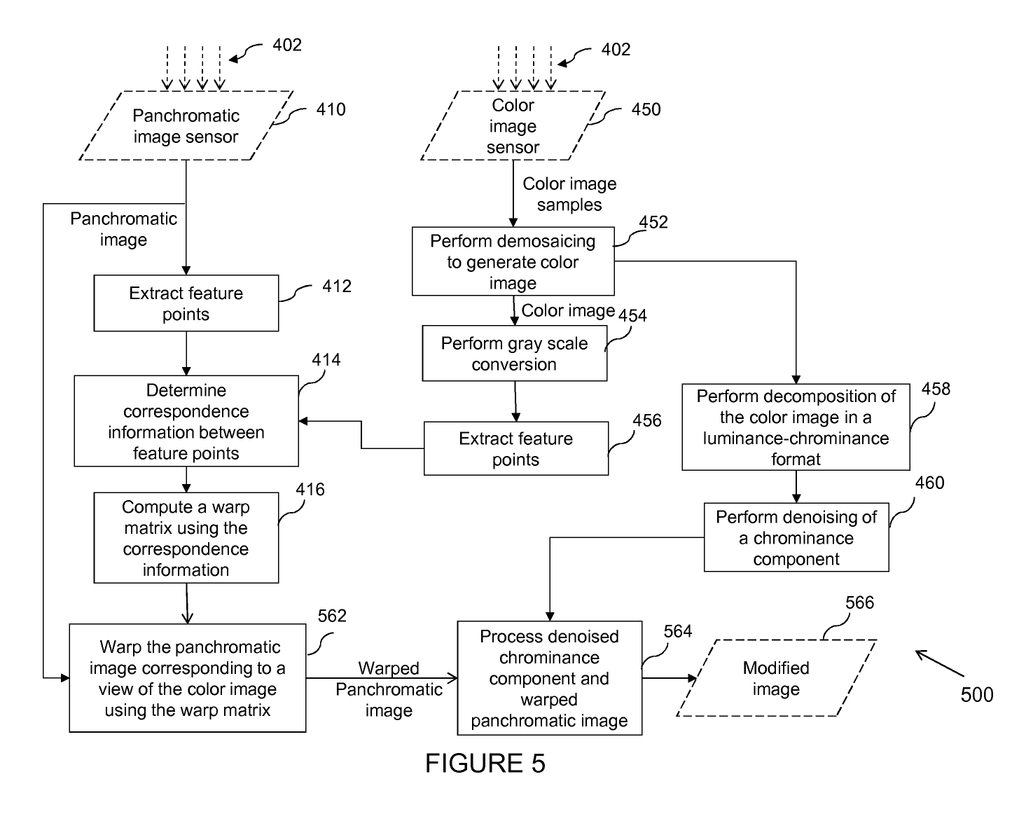

At block 302, the method 300 includes receiving a panchromatic image of a scene captured from a panchromatic image sensor such as a panchromatic image sensor 210 as described in FIG. 2. In an example embodiment, the panchromatic image is a luminance image and a gray scale image with a higher SNR. At block 304, the method 300 includes receiving a color image of the scene captured from a color image sensor. In an example embodiment, the color image is generated from the image samples received from a color image sensor such as the color image sensor 208 as described in FIG. 2. In an example embodiment, the color image is generated by demosaicing the image samples into the color image in primary color format such as RGB image. At block 306, the method 300 includes generating a modified image of the scene based at least in part on processing the panchromatic image and the color image. In an example embodiment, the modified image is generated by combining panchromatic image (for example, the luminance image) and warped chrominance component (using a warp matrix) corresponding to the color image. Such modified image may correspond to an improved image having view of the panchromatic image sensor. In another example embodiment, the modified image can also be generated by combining the chrominance image and a warped panchromatic image (Such warping makes the panchromatic image correspond to the view of the color image sensor). Various example embodiments of capturing images are further described in FIGS. 4 and 5.

FIG. 4 is a flow diagram of example method 400 of capturing images in accordance with an example embodiment. The example method 400 of capturing images may be implemented in or controlled by or executed by, for example, the apparatus 200. It may be understood that for describing the method 400, references herein may be made to FIGS. 1-3. It should be noted that that although the flow diagram of the method 400 shows a particular order, the order need not be limited to the order shown, and more or fewer blocks may be executed, without providing substantial change to the scope of the various example embodiments.

In the flow diagram of the example method 400, image sensors are represented by input blocks 410 (a panchromatic image sensor) and 450 (a color image sensor). In an example embodiment, the panchromatic image sensor 410 is more sensitive to incident light (shown by 402) from a scene than the sensor with a CFA (for example, the color image sensor 450). In an example embodiment, an input image received from the panchromatic image sensor 410 is a panchromatic image. In an example embodiment, the panchromatic image is a high SNR luminance image or a gray scale image. At block 452, an input from the color image sensor 450 (color image samples) is demosaiced to get a color image in primary colors format such as an RGB image.

In an example embodiment, at block 454, the color image such as the RGB image (received from demosaicing the image samples from the color image sensor 450) is converted to a gray scale image. In an example embodiment, at block 456, feature points associated with the color image is determined by determining feature points associated with the gray scale image of the color image. In an example embodiment, feature points are also extracted from the input (for example, the panchromatic image) received from the panchromatic image sensor 410, at block 412. In an example embodiment, feature points associated with the panchromatic image (for example, the luminance image) and feature points associated with the gray scale image of the color image are used to determine a warp matrix. As described in FIG. 2, algorithms such as scale-invariant feature transform (SIFT), harris corner detector, smallest univalue segment assimilating nucleus (SUSAN) corner detector, features from accelerated segment test (FAST) can be used to determine feature points associated with the gray scale image (of the color image) and the luminance image (for example, the panchromatic image).

In an example embodiment, correspondence information between the feature points associated with the luminance image and the feature points associated with the gray scale image is determined at block 414. In an example embodiment, the correspondence information may be determined by algorithms such as random sample consensus (RANSAC). In an example embodiment, the gray scale image (obtained from the color image sensor 450) and the luminance image obtained from the panchromatic image sensor 410 are used to compute the warp matrix (shown by block 416).

In an example embodiment, at block 458, the color image (for example, the RGB image) is decomposed in a luminance-chrominance format to determine luminance and chrominance components. Examples of such format include HSV, HSL, Lab, YUV, YCbCr, and the like. At block 460, the chrominance component of the color image (obtained from the block 458) is denoised to generate smooth chrominance component. In an example embodiment, at block 462, the denoised chrominance component is warped corresponding to the panchromatic image using the warp matrix. In an example embodiment, the warping of the chrominance component causes transformation of the chrominance component of the color image into an analogous chrominance image component as captured from the panchromatic image sensor 410.

In an example embodiment, at block 464, the luminance image from the panchromatic image sensor 410 and the warped chrominance component are processed to generate a modified image 466 from a view of the panchromatic image sensor 410. In an example embodiment, the luminance image and the warped chrominance image may be combined to generate the modified image 466. In an example embodiment, combining the luminance image to the warped chrominance component provides the image of the scene in the primary color format such as in the RGB format. In an example embodiment, the modified image 466 (for example, the RGB image) is an improved image as compared to images individually received from the panchromatic image sensor 410 and the color image sensor 450. For instance, the modified image 466 is an image generated from the luminance image of the panchromatic image sensor 410 and the warped chrominance component in view of the luminance image, which in turn, provides the image with a higher SNR than the color image obtained from the color image sensor 450. As in low light conditions, the luminance image received from the panchromatic image sensor 410 provides a better SNR than a luminance image component from the color image sensor 450, the modified image 466 is generated from processing the luminance image and the warped chrominance component of the color image.

In certain example embodiments, the pixel count (resolution) of the panchromatic image sensor 410 and the color image sensor 450 may be different. For instance, the pixel count of the color image sensor 450 may be lower than that of the panchromatic image sensor 410 for providing a better signal to noise ratio (SNR) for the images captured by the color image sensor 450. For example, the pixel area of the color image sensor 450 increases by reducing the pixel count of the color image sensor 450, the SNR for the images captured by the color image sensor 208 also increase. In such example embodiment, the example method 400 may include upsampling the chrominance component of the color image (for example, by a ratio of the pixel count of the panchromatic image sensor 410 and the pixel count of the color image sensor 450) before warping the chrominance component of the color image corresponding to the panchromatic image using the warp matrix.

FIG. 5 is a flow diagram of example method 500 of capturing images in accordance with another example embodiment. The example method 500 of capturing images may be implemented in or controlled by or executed by, for example, the apparatus 200. It may be understood that for describing the method 500, references herein may be made to FIGS. 1-4. It should be noted that that although the method 500 of FIG. 5 shows a particular order, the order need not be limited to the order shown, and more or fewer blocks may be executed, without providing substantial change to the scope of the various example embodiments.

As already described in FIG. 4, the method 500 include processing of the blocks 412-416 and block 452-456 to generate the warp matrix. The method 500 includes warping the panchromatic image corresponding to a view of the color image using the warp matrix, at block 562. In an example embodiment, the warping of the panchromatic image corresponding to the view of the color image causes transformation of the panchromatic image into an analogous color image as received from the color image sensor 450. In an example embodiment, at block 564, the warped luminance image (received from processing the block 562) and the denoised chrominance component (received from processing the blocks 458 and 460) are processed to generate a modified image 566 from a view of the color image sensor 450. In an example embodiment, the warped luminance image and the chrominance component may be combined to generate the modified image 566. In an example embodiment, combining the warped luminance image to the chrominance component provides the image of the scene in the primary color format such as in the RGB format. In an example embodiment, the modified image 566 (for example, the RGB image) is an improved image as compared to images individually received from the panchromatic image sensor 410 and the color image sensor 450.

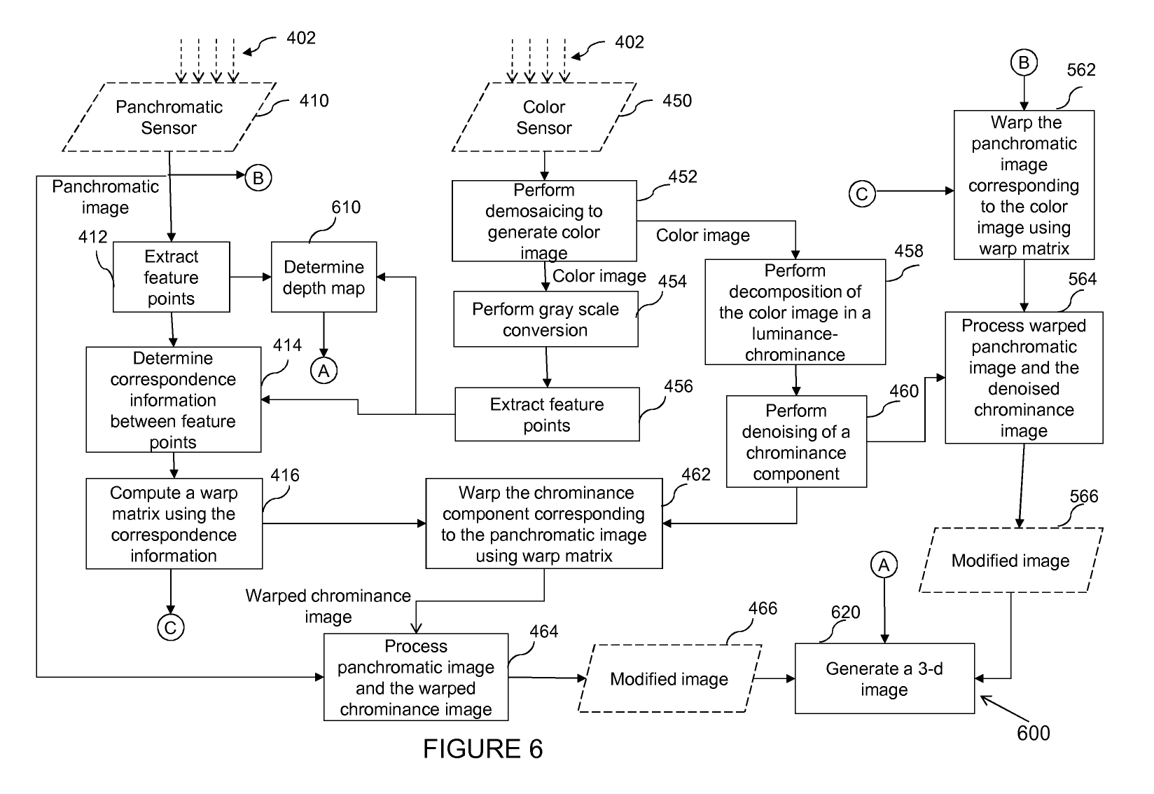

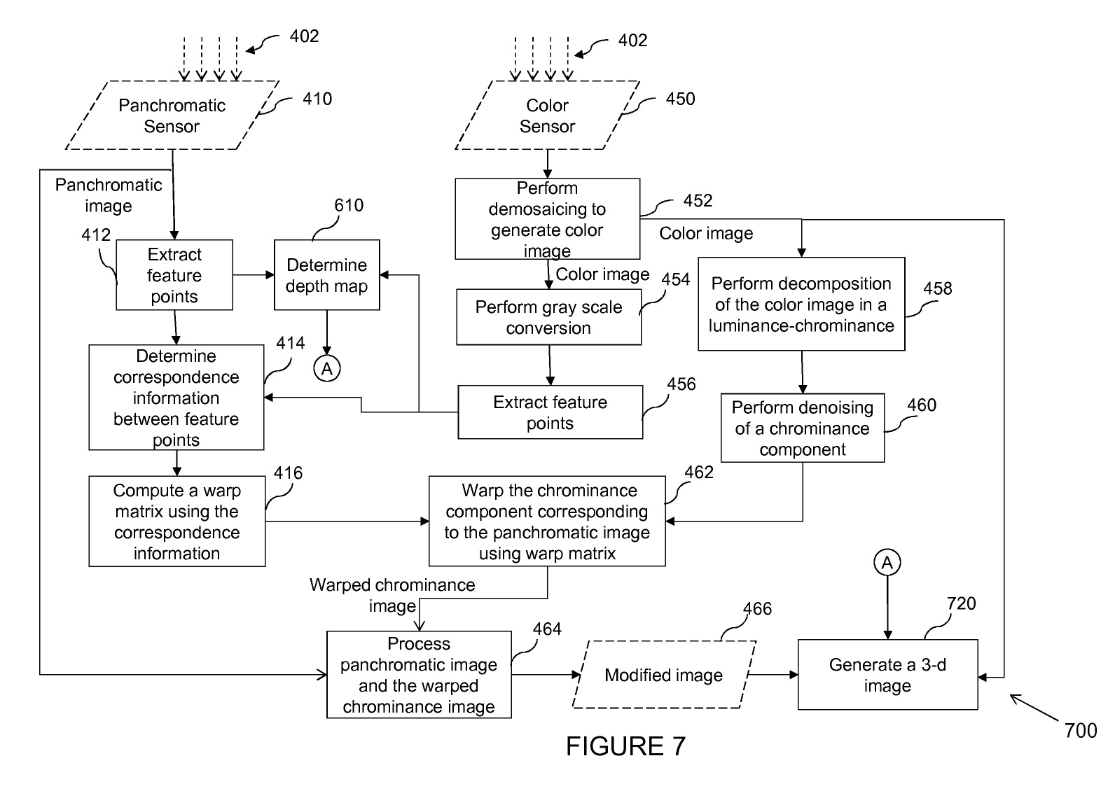

In some example embodiment, both of the modified image 466 and the modified images 566 may be generated for the scene from the images received from the panchromatic sensor 410 and the color sensor 450, simultaneously. Various example embodiments provide generating 3-D images as described in FIGS. 6 and 7.

FIG. 6 is a flow diagram depicting an example method 600 for generating 3-D images in accordance with an example embodiment. The method 600 depicted in flow diagram, may be executed by, for example, the apparatus 200. It may be understood that for describing the method 600, references herein may be made to FIGS. 1-5. It should be noted that that although the method 600 of FIG. 6 shows a particular order, the order need not be limited to the order shown, and more or fewer blocks may be executed, without providing substantial change to the scope of the various example embodiments.

As already described in FIGS. 4 and 5, the method 600 include processing of the blocks 412-416 and 452-464 to generate the modified image 466, and processing of the additional blocks 562 and 564 to generate the modified image 566. As described in FIGS. 4 and 5, both of the modified images 466 and 566 are improved image as compared to images individually received from the panchromatic image sensor 410 and the color image sensor 450.

At block 610, the method 600 includes determining a depth map based on the feature points associated with the panchromatic image (received by processing the block 412) and feature points associated with the gray scale image of the color image (received by processing the block 456). At block 620, the method 500 includes generating a 3-D image based on processing the modified image 466 (received from processing the block 464) and the modified image 566 (received from processing the block 564) using the depth map (received from processing the block 610). The 3-D image obtained from various example embodiments are superior in quality as compared to a 3-D image generated from a stereo pair of color image sensors. As in various example embodiments, the method 600 comprises determining the depth map using the luminance or gray scale images from both the sensors (the sensors 410 and 450), and the method 600 further includes generating the 3-D image from a first color images generated by combining warped and denoised chrominance component and panchromatic image (for example, the modified image 466) and a second color image generated by combining the warped panchromatic image and the denoised chrominance component (for example, the modified image 566).

FIG. 7 is a flow diagram depicting an example method 700 for generating 3-D images in accordance with another example embodiment. The method 700 depicted in flow diagram, may be executed by, for example, the apparatus 200. It may be understood that for describing the method 700, references herein may be made to FIGS. 1-6. It should be noted that that although the method 700 of FIG. 7 shows a particular order, the order need not be limited to the order shown, and more or fewer blocks may be executed, without providing substantial change to the scope of the various example embodiments.

As already described in FIGS. 4 and 5, the method 700 includes processing of the blocks 412-416 and 452-464 to generate the modified image 466. At block 610, the method 700 includes determining a depth map based on the feature points associated with the panchromatic image (received by processing the block 412) and feature points associated with the gray scale image of the color image (received by processing the block 456). At block 720, the method 700 includes generating a 3-D image based on processing the color image (received from processing the block 452) and the modified image 466 (received from processing the block 464) using the depth map (received from processing the block 610). As a result, the 3-D image is generated by utilizing higher sensitivity of the luminance images (captured by the sensor 410) in low light conditions, and color images of the color image sensor 450, and accordingly, the 3-D image generated by various example embodiments offer a superior quality as compared to a 3-D image generated from a stereo pair of color image sensors.

Operations of the flowcharts/flow diagrams 300-700, and combinations of operations in the flowcharts/flow diagrams 300-700, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowcharts/flow diagrams 300-700. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods 300-700 are described with help of the apparatus 200. However, the operations of the methods 300-700 can be described and/or practiced by using any other apparatus.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-43. (canceled)

44. A method comprising:
receiving a panchromatic image of a scene captured from a panchromatic image sensor;
receiving a colour image of the scene captured from a colour image sensor; and
generating a modified image of the scene based at least in part on processing the panchromatic image and the colour image.

45. The method as claimed in claim 44, wherein generating the modified image comprises:
determining a warp matrix based on feature points associated with panchromatic image and feature points associated with the colour image;
determining a chrominance component associated with the colour image;
warping the chrominance component associated with the colour image corresponding to the panchromatic image using the warp matrix; and
generating the modified image from view of the panchromatic image sensor based on processing the panchromatic image and the warped chrominance component.

46. The method as claimed in claim 44, wherein generating the modified image comprises:
determining a warp matrix based on feature points associated with panchromatic image and feature points associated with the colour image;
determining a chrominance component associated with the colour image;
warping the panchromatic image corresponding to a view of the chrominance component using the warp matrix; and
generating the modified image from view of the colour image sensor based on processing the chrominance component and the warped panchromatic image.

47. The method as claimed in claim 46, wherein determining the warp matrix comprises:
performing a grey scale conversion of the colour image to generate a grey scale image of the colour image;
determining the feature points associated with the colour image by determining feature points associated with the grey scale image;
determining the feature points associated with the panchromatic image;
determining correspondence information between the feature points associated with the grey scale image and the feature points associated with the panchromatic image; and
computing the warp matrix based on the correspondence information.

48. The method as claimed in claim 45, wherein determining the chrominance component comprises:
performing a demosacing of image samples received from the colour image sensor to generate the colour image, wherein the colour image is in a primary colour format; and
performing decomposition of the colour image to determine a luminance component and the chrominance component.

49. The method as claimed in claim 45, wherein warping the chrominance component comprises:
denoising the chrominance component; and
warping the denoised chrominance component corresponding to the panchromatic image using the warp matrix.

50. The method as claimed in claim 45, further comprises:
determining a depth map based on the feature points associated with the panchromatic image and the feature points associated with the colour image; and
generating a three-dimensional image of the scene based on processing the modified image from the view of the panchromatic image sensor and the modified image from the view of the colour image sensor using the depth map.

51. The method as claimed in claim 45, further comprising:
determining a depth map based on the feature points associated with the panchromatic image and the feature points associated with the colour image; and
generating a three-dimensional image of the scene based on processing of the colour image and the modified image from the view of the panchromatic image sensor.

52. The method as claimed in claim 44, further comprising:
upsampling the chrominance component of the colour image prior to warping the chrominance component, wherein a pixel count of the colour image sensor is less than a pixel count of the panchromatic image sensor.

53. An apparatus comprising:
at least one processor; and
at least one memory comprising computer program code, the at least one memory and the computer program code configured to, with the at least one processor, cause the apparatus at least to perform:
receive a panchromatic image of a scene captured from a panchromatic image sensor;
receive a colour image of the scene captured from a colour image sensor; and
generate a modified image of the scene based at least in part on processing the panchromatic image and the colour image.

54. The apparatus as claimed in claim 53, wherein, to generate the modified image, the apparatus is further caused, at least in part, to perform:
determine a warp matrix based on feature points associated with panchromatic image and feature points associated with the colour image;
determine a chrominance component associated with the colour image;
warp the chrominance component of the colour image corresponding to the panchromatic image using the warp matrix; and
generate the modified image from view of the panchromatic image sensor based on processing the panchromatic image and the warped chrominance component.

55. The apparatus as claimed in claim 53, wherein, to generate the modified image, the apparatus is further caused, at least in part, to perform:
determine a warp matrix based on feature points associated with panchromatic image and feature points associated with the colour image;
determine a chrominance component associated with the colour image;
warp the panchromatic image corresponding to a view of the chrominance component using the warp matrix; and
generate the modified image from view of the colour image sensor based on processing the chrominance component and the warped panchromatic image.

56. The apparatus as claimed in claim 55, wherein, to generate the warp matrix, the apparatus is further caused, at least in part, to perform:
perform a grey scale conversion of the colour image to generate a grey scale image of the colour image;
determine the feature points associated with the colour image by determining feature points associated with the grey scale image;
determine the feature points associated with the panchromatic image;
determine correspondence information between the feature points associated with the grey scale image and the feature points associated with the panchromatic image; and
compute the warp matrix based on the correspondence information.

57. The apparatus as claimed in claim 54, wherein, to generate the chrominance component, the apparatus is further caused, at least in part, to perform:
demosac image samples received from the colour image sensor to generate the colour image, wherein the colour image is in a primary colour format; and
decompose the colour image to determine a luminance component and the chrominance component.

58. The apparatus as claimed in claim 54, wherein, to warp the chrominance component, the apparatus is further caused, at least in part, to perform:
denoise the chrominance component; and
warp the denoised chrominance component corresponding to the panchromatic image using the warp matrix.

59. The apparatus as claimed in claim 54, wherein the apparatus is further caused, at least in part, to perform:
determine a depth map based on the feature points associated with the panchromatic image and the feature points associated with the colour image; and
generate a three-dimensional image of the scene based on processing the modified image from the view of the panchromatic image sensor and the modified image from the view of the colour image sensor using the depth map.

60. The apparatus as claimed in claim 54, wherein the apparatus is further caused, at least in part, to perform:
determine a depth map based on the feature points associated with the panchromatic image and the feature points associated with the colour image; and
generate a three-dimensional image of the scene based on processing of the colour image and the modified image from the view of the panchromatic image sensor.

61. The apparatus as claimed in claim 53, wherein the apparatus is further caused, at least in part, to perform:
upsample the chrominance component of the colour image prior to warping the chrominance component, wherein a pixel count of the colour image sensor is less than a pixel count of the panchromatic image sensor.

62. A computer program product comprising at least one computer-readable storage medium, the computer-readable storage medium comprising a set of instructions, which, when executed by one or more processors, cause an apparatus at least to perform:
receive a panchromatic image of a scene captured from a panchromatic image sensor;
receive a colour image of the scene captured from a colour image sensor; and
generate a modified image of the scene based at least in part on processing the panchromatic image and the colour image.

63. The computer program product as claimed in claim 62, wherein, to generate the modified image, the apparatus is further caused, at least in part, to perform:
determine a warp matrix based on feature points associated with panchromatic image and feature points associated with the colour image;
determine a chrominance component associated with the colour image;
warping the chrominance component of the colour image corresponding to the panchromatic image using the warp matrix; and
generate the modified image from view of the panchromatic image sensor based on processing the panchromatic image and the warped chrominance component.
